(19) United States
(12) Patent Application Publication
(10) Pub. No.: US 2007/0126372 A1
(43) Pub. Date: Jun. 7, 2007

(54) Power supply devices

(75) Inventors: Shih-Chung Huang, Taipei (TW); Chin-Fa Kao, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Beyond Innovation Technology Co., Ltd

(21) Appl. No.: 11/337,640

(22) Filed: Jan. 23, 2006

(30) Foreign Application Priority Data
Dec. 1, 2005 (TW) 94142345

(51) Int. Cl. H05B 41/36

(52) U.S. Cl. 315/291

(57) ABSTRACT

Disclosed is a power supply device driving lamp(s). An electrical isolation driver generates at least one switch signal according to at least one control signal. The control signal and the switch signal are electrically isolated from each other. A switch unit receives a voltage from a DC power source and switches the voltage to an oscillation signal. An electrical isolation transformer has a primary side and a secondary side. The primary side is coupled to the switch unit and receives the oscillation signal. The secondary side outputs an operating signal to drive the lamp. A controller generates the control signal according to a feedback signal indicating the electrical states of the lamp. The DC power source, the switch unit, and the primary side are coupled to a first ground. The secondary side and the controller are coupled to a second ground.

### CROSS REFERENCE TO RELATED APPILCATIONS

This application claims the benefit of Taiwan application Serial No. 94142345 filed Dec. 1, 2005, the subject matter of which is incorporated herein by reference.

### BACKGROUND OF THE INVENTION

1. Field of the Invention

The present invention relates to a power supply device, and in particular relates to a DC/AC (direct current to alternating current) power supply device to drive a lamp.

2. Description of the Related Art

Fluorescent lamps transforming electricity into light are often used as light sources to provide required illumination. To provide stable light from fluorescent lamps, a DC/AC (direct current to alternating current) power supply device is usually designed to provide a high frequency AC signal of about 50 KHz to the fluorescent lamps.

FIG. 1 is a conventional DC/AC power supply. A DC/AC power supply 1 comprises a buck converter 102, a self-resonant DC/AC inverter 103, a fluorescent lamp 104, a load indicator 105, and a signal generator 106. The self-resonant DC/AC inverter 103 comprises a transformer 114 with multiple outputs, a resonance capacitor 115, a blocking capacitor 116, resistors 117 and 118, and transistors 119 and 120. The buck converter 102 comprises a power switch unit 111, a diode 112, and an inductor 113. The buck converter 102 and the self-resonant DC/AC inverter 103 are together referred to a fluorescent lamp driving circuit.

Referring to FIG. 1, a DC power source 101 provides DC voltage to the buck converter 102 and the self-resonant DC/AC inverter 103 of the fluorescent lamp driving circuit. The buck converter 102 converts the voltage from the DC voltage of the DC power source 101 to lower DC voltage in advance and provides the lower DC voltage to the self-resonant DC/AC inverter 103. The self-resonant DC/AC inverter 103 inverts the voltage from the DC power source 101 and the lower DC voltage from the buck converter 102 to AC voltage and provides the AC voltage to the fluorescent lamp 104. The load indicator 105 is coupled to the fluorescent lamp 104, detects the operating current flowing through the fluorescent lamp 104, and transmits the detected current value to the signal generator 106. The signal generator 106 receives the detected current value and outputs a pulse width modulation (PWM) control signal to the buck converter 102 of the fluorescent lamp driving circuit. After the power switch unit 111 of the. buck converter 102 receives the PWM control signal, the power switch unit 111 controls the lower DC voltage to the self-resonant DC/AC inverter 103 through the diode 112 and the inductor 113. The power switch unit 111 further controls the operating current of the fluorescent lamp 104 according to the PWM control signal.

Referring to FIG. 1, the DC power source 101 is generally an AC/DC converter with no electrical isolation. The buck converter 102, the self-resonant DC/AC inverter 103, the fluorescent lamp 104, the load indicator 105, and the signal generator 106 are all coupled to a ground GND and have no electrical isolation with each other. The conventional power supply, thus, can not achieve the desired electrical isolation effect.

### BRIEF SUMMARY OF THE INVENTION

Power supply devices are provided. An exemplary embodiment of a power supply device for driving at least one lamp comprises an electrical isolation driver, a switch unit, an electrical isolation transformer, and a controller. The electrical isolation driver receives at least one control signal and generates at least one corresponding switch signal according to the at least one control signal. The at least one control signal and the at least one switch signal are electrically isolated from each other. The switch unit receives a voltage from a DC power source and switches the voltage from the DC power source to an oscillation signal. The electrical isolation transformer has a primary side and a secondary side. The primary side is coupled to the switch unit and receives the oscillation signal, and the secondary side outputs an operating signal to drive the lamp. The controller receives a feedback signal indicating the electrical states of the lamp and generates the at least one control signal according to the feedback signal. The DC power source, the switch unit, and the primary side of the electrical isolation transformer are coupled to a first ground. The secondary side of the electrical isolation transformer and the controller are coupled to a second ground.

Another exemplary embodiment of a power supply device drives at least one load and comprises a DC isolation power unit and a DC/AC inverter. The DC isolation power unit has a primary side and a secondary side. The primary side is coupled to an AC voltage source, and the secondary side provides a DC voltage according to the AC voltage source. The DC/AC inverter inverts the DC voltage to an AC signal to drive the load. The primary side is coupled to a first ground, and the secondary side and the DC/AC inverter are coupled to a second ground.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional DC/AC power supply power;

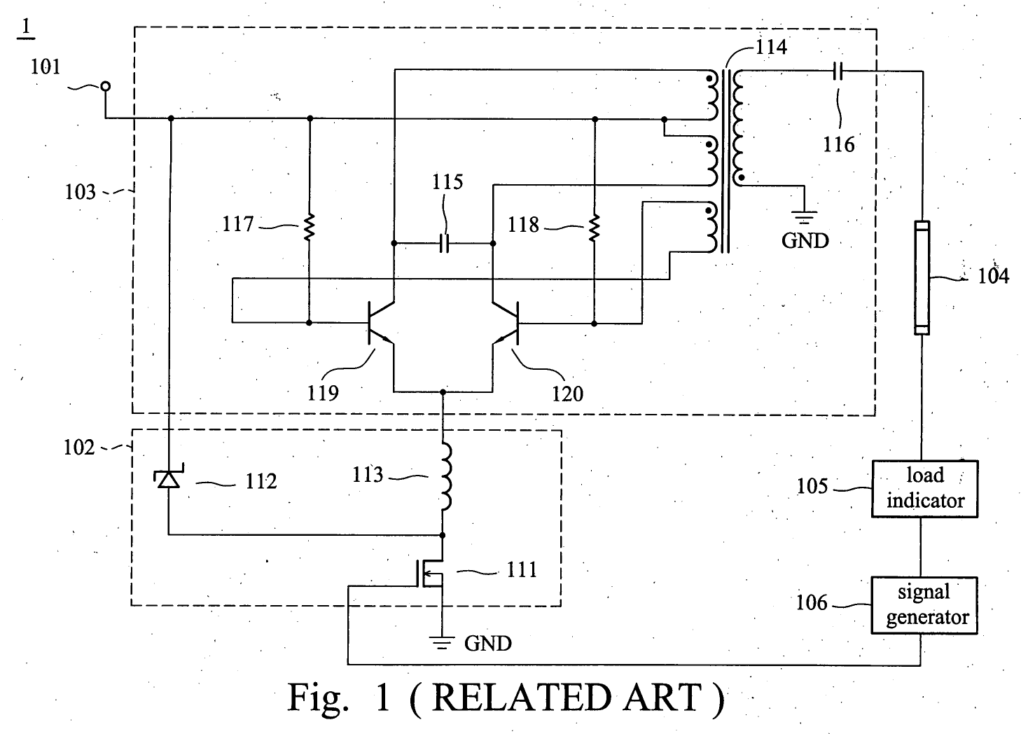

FIG. 2 depicts an embodiment of a power supply source.

FIG. 3 depicts control signals and an operating signal in FIG. 2.

FIG. 4 shows an example of driving units of an electrical isolation driver in FIG. 2.

FIG. 5 shows another example of driving units of an electrical isolation driver in FIG. 2.

FIG. 6 depicts an embodiment of a power supply source.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

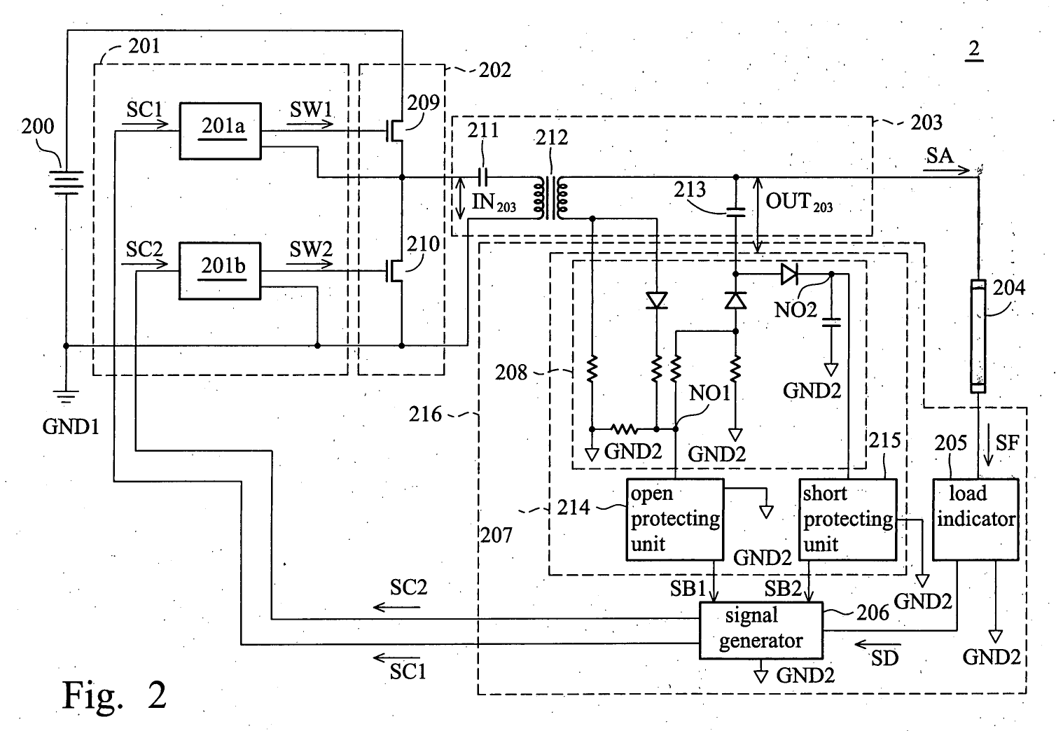

Power supply devices are provided. In an exemplary embodiment of a power supply device in FIG. 2, a power supply device 2 comprises an electrical isolation driver 201, a power switch unit 202, a resonance network 203, a fluorescent lamp (load) 204, and a controller 216. The controller 216 comprises a load indicator 205, a signal generator 206, and a detector 207. The electrical isolation driver 201 comprises one set of driving units 201a and 201b. Each of the driving units 201a and 201b provides an effect of electrical isolation, so that input and output terminals of the electrical isolation driver 201 are electrically isolated from each other. The power switch unit 202 comprises a set of half bridge switches 209 and 210. The resonance network 203 comprises a blocking capacitor 211, an electrical isolation transformer 212, and a resonance capacitor 213. The resonance network 203 has characteristics of a band-pass filter. The electrical isolation transformer 212 provides the effects of the power transformation and the electrical isolation. The switches 209 and 210, the blocking capacitor 211, the electrical isolation transformer 212, and the resonance capacitor 213 compose a power system of a half bridge DC/AC inverter.

As shown in FIG. 2, a DC power source 200 provides DC voltage to the power switch unit 202. The power switch unit 202 is coupled between the output terminal of the electrical isolation driver 201 and the primary side IN₂₀₃ of the resonance network 203. One terminal of the fluorescent lamp 204 is coupled to the secondary side OUT₂₀₃ of the resonance network 203, and the other terminal thereof is coupled to the load indicator 205. An input terminal of the signal generator 206 is coupled to the load indicator 205 and the detector 207. Two output terminals of the signal generator 206 are coupled to the input terminals of the electrical isolation driver 201. Since the electrical isolation transformer 212 provides an effect of electrical isolation, the primary side IN₂₀₃ and the secondary side OUT₂₀₃ of the resonance network 203 are electrically isolated from each other.

A control terminal of the switch 209 is coupled to the driving unit 201a, an input terminal thereof is coupled to the DC power source 200, and an output terminal thereof is coupled to the primary side IN₂₀₃ of the resonance network 203. A control terminal of the switch 210 is coupled to the driving unit 201b, an input terminal thereof is coupled to the DC power source 200, and an output terminal thereof is coupled to the primary side IN₂₀₃ of the resonance network 203. In FIG. 2, N-type transistors are taken as an example to be the switches 209 and 210. The control terminals, input terminals, and output terminals of the switches 209 and 210 respectively correspond to gates, drains, and sources of the N-type transistors.

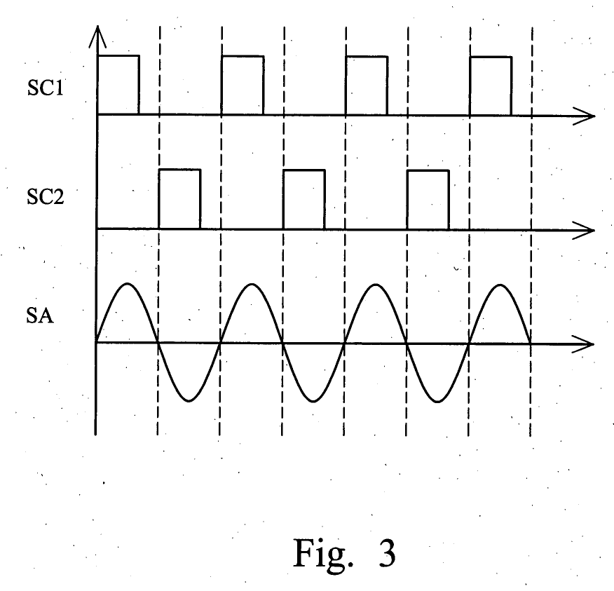

The DC power source 200 provides the DC voltage to the power switch unit 202. The signal generator 206 outputs pulse width modulation (PWM) control signals SC1 and SC2 in a normal mode. The electrical isolation driver 201 receives the PWM control signals SC1 and SC2. The driving units 201a and 201b output switch signals SW1 and SW2 according to the PWM signals SC1 and SC2, respectively. Referring to FIG. 3, there is a 180° phase difference between the PWM.control signals SC1 and SC2. Thus, there is also a 180° phase difference between the switch signals SW1 and SW2 output from the driving units 201a and 201b, so that the switches 209 and 210 are turned on alternately. The power switch unit 202 switches the DC voltage provided by the DC power source 200 to an oscillation signal and outputs it to the resonance network 203. The oscillation signal is a square wave signal. The resonance network 203 transforms the oscillation signal to an operating signal SA by the characteristics of the band-pass filter to drive the fluorescent lamp 204. The operating signal SA is an AC sine wave signal, as shown in FIG. 3. The load indicator 205 receives a feedback signal SF indicating the electrical states of the fluorescent lamp 204 and outputs an indication signal SD according to the feedback signal SF. In this embodiment, the feedback signal SF can be a signal related to the operating current of the fluorescent lamp 204, and the load indicator 205 generates the indication signal SD according to the operating current of the fluorescent lamp 204. The signal generator 206 changes and regulates the PWM control signals SC1 and SC2 according to the indication signal SD. The switch signals SW1 and SW2 are regulated according to the regulated PWM control signals SC1 and SC2, and the operating current of the fluorescent lamp 204 is further controlled.

Referring to FIG. 2, the detector 207 detects that the fluorescent lamp 204 is in an open or short state. When the fluorescent lamp 204 is in an open or short state, the detector 207 outputs a stop signal to the signal generator 206, so that the signal generator 206 stops outputting the control signals SC1 and SC2. The detailed operation will be described.

As shown in FIG. 2, the detector 207 comprises a voltage detection circuit 208, an open protecting unit 214, and a short protecting unit 215. When the fluorescent lamp 204 is in an open state, voltage at a node NO1 of the voltage detection circuit 208 is gradually reduced. When the voltage at the node NO1 is lower than a first predetermined voltage, the open protecting unit 214 outputs a stop signal SB1 to the signal generator 206. The signal generator 206 stops outputting the PWM control signals SC1 and SC2 according to the stop signal SB1. When the fluorescent lamp 204 is in a short state, voltage at a node NO2 of the voltage detection circuit 208 is gradually reduced. When the voltage at the node NO2 is lower than a second predetermined voltage, the short open protecting unit 215 outputs a stop signal SB2 to the signal generator 206. The signal generator 206 stops outputting the PWM control signals SC1 and SC2 according to the stop signal SB2. In other words, when the detector 207 detects that the fluorescent lamp 204 is in one of the open and short states, the signal generator 206 stops outputting the PWM control signal SC1 and SC2.

In the embodiment of FIG. 2, the signal generator 206 and the power switch unit 202 are electrically isolated from each other by the effect of electrical isolation of the driving units 201a and 201b, and the fluorescent lamp 204 and the DC power source 200 are electrically isolated from each other by the effect of electrical isolation of the electrical isolation transformer 212. Referring to FIG. 2, the DC power source 200, the power switch unit 202, and the primary side IN₂₀₃ of the electrical isolation transformer 212 are coupled to a ground GND1. The secondary side OUT₂₀₃ of the electrical isolation transformer 212, the fluorescent lamp 204, the load indicator 205, the signal generator 206, and the detector 207 are coupled to a ground GND2.

In the embodiment of FIG. 2, the power switch unit 202 is a half bridge type. In practice, the power switch unit 202 can be a Royer type, a push-pull type, a half bridge, or a full bridge type, so that the number of the control signals, the switch signals, or the related signals can be determined according to the type of the power switch unit 202.

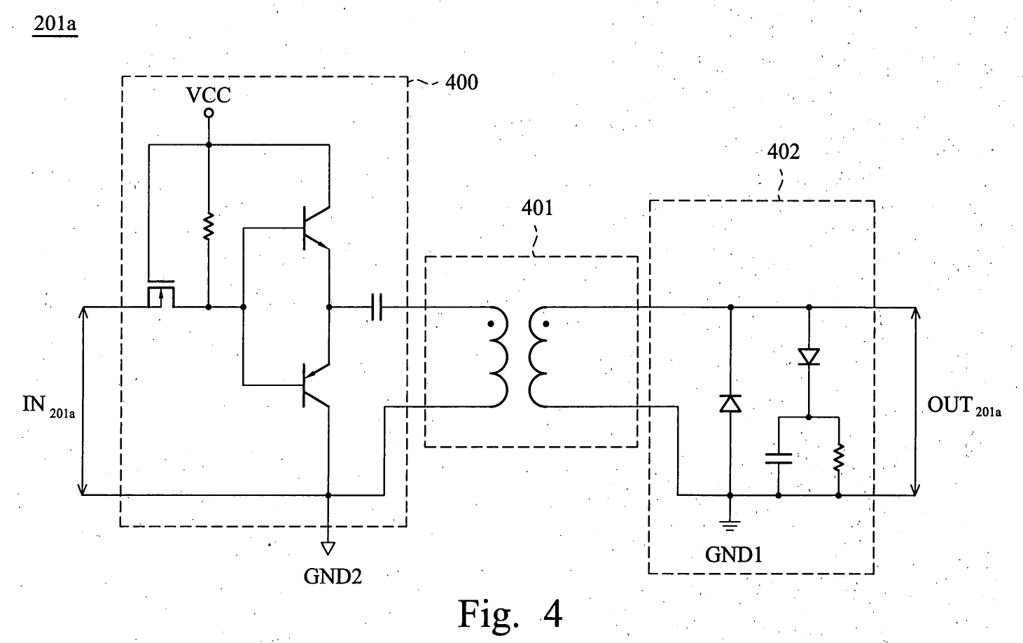

FIG. 4 is an example of the driving units of the electrical isolation driver 201 in FIG. 2. In the following description, the driving unit 201a is taken as an example. The driving unit 201a of FIG. 4 comprises a power amplifier 400, a transformer element 401, and an output buffer 402. In FIG. 4, the transformer element 401 is a pulse transformer. The driving unit 201a has a primary side IN₂₀₁ₐ and secondary side OUT₂₀₁ₐ. The power amplifier 400 is coupled to the primary side IN₂₀₁ₐ. The pulse transformer 401 is coupled between the power amplifier 400 and the output buffer 402. The output buffer 402 is coupled to the secondary side OUT₂₀₁ₐ. The power amplifier 400 receives the PWM control signal SC1 from the signal generator 206 through the primary side IN₂₀₁ₐ. The power amplifier 400 amplifies the power of the PWM control signal SC1 and regulates the level thereof. The operations of the power amplification and level regulation can filter DC components in the signal transmitted to the pulse transformer 401. The pulse transformer 401 transforms the voltage of the signal from the power amplifier 400 and outputs an AC signal. At the same time, the pulse transformer 401 transforms the signal from the power amplifier 400 to a non-electric signal and then to the electric AC signal. The output buffer 402 changes the level of the AC signal from the pulse transformer 401 to generate the switch signal SW1 and outputs the switch signal SW1 to the switch 209 through the secondary side OUT₂₀₁ₐ. Similarly, the driving unit 201b also comprises a power amplifier 400, a transformer element 401, and an output buffer 402 and receives the PWM control signal SC2 from the signal generator 206. Accordingly, each driving unit of the electrical isolation driver 201 can perform power amplification and level regulation of the PWN control signal and provide the electrical isolation for controlling the switches 209 and 210.

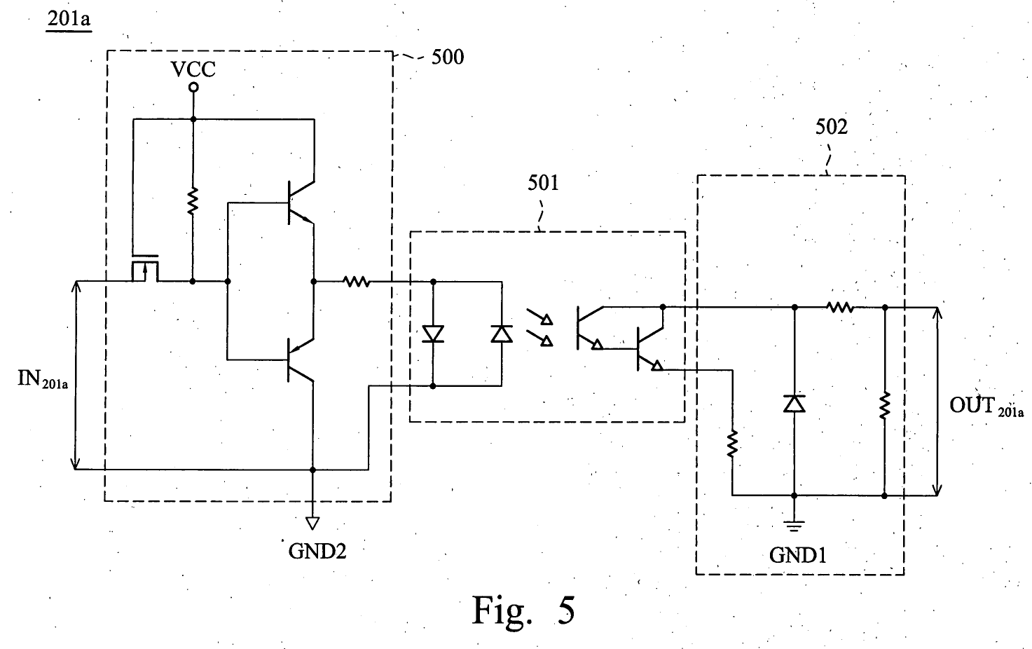

FIG. 5 is another example of the driving units of the electrical isolation driver 201 in FIG. 2. In the following description, the driving unit 201a is taken as an example. The driving unit 201 a of FIG. 5 comprises a power amplifier 500, a transformer element 501, and an output buffer 502. In FIG. 5, the transformer element 501 is a photo coupler. The driving unit 201a has a primary side IN₂₀₁ₐ and secondary side OUT₂₀₁ₐ. The power amplifier 500 is coupled to the primary side IN₂₀₁ₐ. The photo coupler 501 is coupled between the power amplifier 500 and the output buffer 502. The output buffer 502 is coupled to the secondary side OUT₂₀₁ₐ. The primary side IN₂₀₁ₐ and secondary side OUT₂₀₁ₐ are electrically isolated from each other due to the electrical isolation of the photo coupler 501.

The power amplifier 500 receives the PWM control signal SC1 from the signal generator 206 through the primary side IN₂₀₁ₐ. The power amplifier 500 amplifies the power of the PWM control signal SC1 and regulates the level thereof. The operations of the power amplification and level regulation can enhance the driving capability of the photo coupler 501. The photo coupler 501 is driven and generates a voltage signal. At the same time, the photo coupler 501 transforms the signal from the power amplifier 500 to a non-electric signal and then to the voltage signal. The output buffer 502 changes the level of the voltage signal from the photo coupler 501 to generate the switch signal SW1 and outputs the switch signal SW1 to the switch 209 through the secondary side OUT₂₀₁ₐ. Similarly, the driving unit 201b also comprises a power amplifier 500, a transformer element 501, and an output buffer 502, and receives the PWM control signal SC2 from the signal generator 206. Accordingly, each driving unit of the electrical isolation driver 201 can perform power amplification and level regulation of the PWM control signal and provide electrical isolation for controlling the switches 209 and 210.

In the electrical isolation driver 201, if the power and the level of the signal at the primary side have no need to be amplified and regulated, the power amplifier can be omitted. Moreover, if the level of the signal at the secondary side has no need to be changed, the output buffer can be omitted.

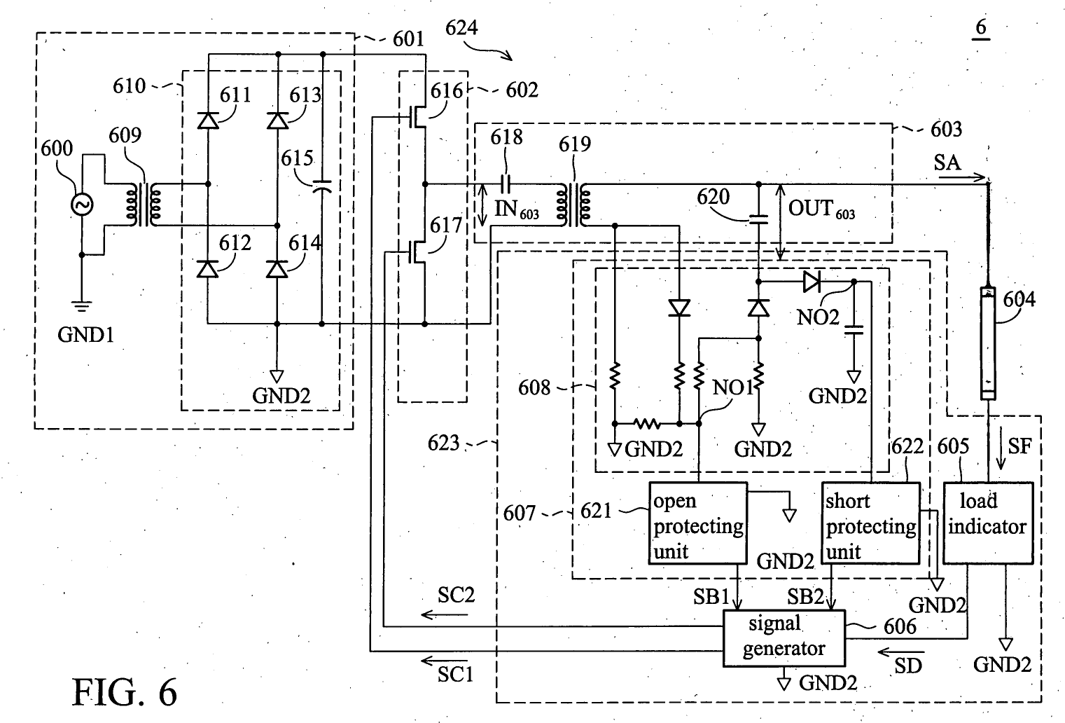

In an exemplary embodiment of a power supply device in FIG. 6, a power supply device 6 comprises a DC isolation power unit 601, a fluorescent lamp 604, and a DC/AC inverter 624. Referring to FIG. 6, the DC/AC inverter 624 comprises a power switch unit 602, a resonance network 603, and a controller 623. The controller 623 comprises a load indicator 605, a signal generator 606, and a detector 607. The DC isolation power unit 601 comprises a main power source (AC voltage source) 600, a transformer element 609, and a rectifier 610. The transformer element 609 is an electrical isolation transformer and provides electrical isolation, so that a secondary side of the DC isolation power unit 601 and the main power source 600 are electrically isolated from each other. The rectifier 610 is composed by diodes 611 to 614 and a capacitor 615. The power switch unit 602 comprises a set of half bridge switches 616 and 617. The resonance network 603 comprises a blocking capacitor 618, a transformer 619, and a resonance capacitor 620. The resonance network 603 has characteristics of a band-pass filter. The transformer 619 provides power transformation. The switches 616 and 617, the blocking capacitor 618, the transformer 619, and the resonance capacitor 620 serve as a power system of a half bridge DC/AC inverter.

As shown in FIG. 6, the DC isolation power unit 601 provides DC voltage to the power switch unit 602. The power switch unit 602 is coupled between the secondary side of DC isolation power unit 601 and the primary side IN₆₀₃ of the resonance network 603. One terminal of the fluorescent lamp 604 is coupled to the secondary side OUT₆₀₃ of the resonance network 603, and the other terminal thereof is coupled to the load indicator 605. An input terminal of the signal generator 606. is coupled to the load indicator 605 and the detector 607. Two output terminals of the signal generator 606 are coupled to the switches 616 and 617.

A control terminal of the switch 616 is coupled to the output. terminal of the signal generator 606, an input terminal thereof is coupled to the DC isolation power unit 601, and an output terminal thereof is coupled to the primary side IN₆₀₃ of the resonance network 603. A control terminal of the switch 617 is coupled to the output terminal of the signal generator 606, and an input and output terminals thereof are coupled to the primary side IN₆₀₃ of the resonance network 603. In FIG. 6, N-type transistors are given as an example of the switches 616 and 617. The control terminals, input terminals, and output terminals of the switches 616 and 617 respectively correspond to gates, drains, and sources of the N-type transistors.

A primary side of the DC isolation power unit 601 is coupled to the main power source 600. The electrical isolation transformer 609 transforms the AC voltage from the main power source 600. At the same time, the electrical isolation transformer 609 transforms the AC voltage to a non-electric signal and then to an electric signal. The rectifier 610 converts the transformed AC voltage to DC voltage and outputs it through the secondary side of the DC isolation power unit 601. Since the electrical isolation transformer 609 provides the effect of electrical isolation, the rectifier 610 and the main power source 600 are electrically isolated from each other. The signal generator 606 outputs pulse width modulation (PWM) control signals SC1 and SC2 in a normal mode. The switches 616 and 617 of the power switch unit 602 respectively receive the PWM control signals SC1 and SC2 and are turned on alternately according to the PWM control signals SC1 and SC2. The power switch unit 602 switches the DC voltage provided by the DC isolation power unit 601 to an oscillation signal and outputs it to the resonance network 603. The oscillation signal is a square wave signal. The resonance network 603 transforms the oscillation signal to an operating signal SA by the characteristics of the band-pass filter to drive the fluorescent lamp 604. The operating signal SA is AC sine wave signal. The load indicator 605 receives a feedback signal SF indicating the electrical states of the fluorescent lamp 604 and outputs an indication signal SD according to the feedback signal SF. In this embodiment, the feedback signal SF can be a signal related to the operating current of the fluorescent lamp 604, and the load indicator 605 generates the indication signal SD according to the operating current of the fluorescent lamp 604. The signal generator 606 changes and regulates the PWM control signals SC1 and SC2 according to the indication signal SD. The switch signals SW1 and SW2 are regulated according to the regulated PWM control signals SC1 and SC2, and the operating current of the fluorescent lamp 604 is further controlled.

Referring to FIG. 6, the detector 607 detects that the fluorescent lamp 604 is in an open or short state. When the fluorescent lamp 604 is in an open or short state, the detector 607 outputs a stop signal to the signal generator 606, so that the signal generator 606 stops outputting the control signals SC1 and SC2. The detailed operation is described in the following.

As shown in FIG. 6, the detector 607 comprises a voltage detection circuit 608, an open protecting unit 621, and a short protecting unit 622. When the fluorescent lamp 604 is in an open state, voltage at a node NO1 of the voltage detection circuit 608 is gradually reduced. When the voltage at the node NO1 is lower than a first predetermined voltage, the open protecting unit 621 outputs a stop signal SB1 to the signal generator 606. The signal generator 606 stops outputting the PWM control signals SC1 and SC2 according to the stop signal SB1. When the fluorescent lamp 604 is in a short state, voltage at a node NO2 of the voltage detection circuit 608 is gradually reduced. When the voltage at the node NO2 is lower than a second predetermined voltage, the short open protecting unit 622 outputs a stop signal SB2 to the signal generator 606; The signal generator 606 stops outputting the PWM control signals SC1 and SC2 according to the stop signal SB2. In other words, when the detector 607 detects that the fluorescent lamp 604 is at one of the open and short states, the signal generator 606 stops outputting the PWM control signal SC1 and SC2.

In the embodiment of FIG. 6, the fluorescent lamp 604 and the main power source 600 are electrically isolated from each other by the effect of electrical isolation of the electrical isolation transformer 609. Referring to FIG. 6, the primary side of the DC isolation power unit 601 is coupled to ground GND1. The secondary side of the DC isolation power unit 601, the power switch unit 602, the resonance network 603, the fluorescent lamp 604, the load indicator 605, the signal generator 606, the detector 607, and the rectifier 610 are coupled to a ground GND2.

In the embodiments of FIGS. 2 and 6, one fluorescent lamp is taken as an example. A plurality of fluorescent lamp can be used in practice.

In the embodiments of FIGS. 2 and 6, a pulse transformer and a photo coupler are taken as examples of the transformer element. In practice, a coil transformer, a piezoelectricity transformer, or the element which transforms electric energy to other energy and then transforms that energy back to the electric energy can be a transformer element to provide the effect of electrical isolation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power supply device driving at least one lamp, comprising:
an electrical isolation driver receiving at least one control signal and generating at least one corresponding switch signal according to the at least one control signal, wherein the at least one control signal and the at least one switch signal are electrically isolated from each other;
a switch unit receiving a voltage from a DC power source and switching the voltage from the DC power source to an oscillation signal according to the at least one switch signal;
an electrical isolation transformer having a primary side and a secondary side, wherein the primary side is coupled to the switch unit and receives the oscillation signal, and the secondary side outputs an operating signal to drive the lamp; and
a controller receiving a feedback signal indicating the electrical state of the lamp and generating the at least one control signal according to the feedback signal;
wherein the DC power source, the switch unit, and the primary side of the electrical isolation transformer are coupled to a first ground, the secondary side of the electrical isolation transformer and the controller are coupled to a second ground.

2. The power supply device as claimed in claim 1, wherein the oscillation signal is a square wave signal.

3. The power supply device as claimed in claim 2, wherein the controller comprises:
a load indicator receiving the feedback signal and generating an indication signal; and
a signal generator generating the at least one control signal according to the indication signal.

4. The power supply device as claimed in claim 3, wherein the controller further comprises:
a detector detecting that the lamp is in an open or short state;
wherein the detector outputs a stop signal to the signal generator when the lamp is in the open or short state, so that the signal generator stops outputting the at least one control signal.

5. The power supply device as claimed in claim 2, wherein the at least one control signal is a pulse width modulation (PWM) signal.

6. The power supply device as claimed in claim 2, wherein the electrical isolation driver comprises:
a transformer element receiving the at least one control signal, transforming the at least one control signal to at least one non-electric signal and then transforming the at least one non-electric signal to at least one electric signal.

7. The power supply device as claimed in claim 6, wherein the transformer element is a pulse transformer, a photo coupler, a coil transformer, or a piezoelectricity transformer.

8. The power supply device as claimed in claim 6, wherein the electrical isolation driver further comprises:
a power amplifier amplifying the power of the at least one control signal and outputting the at least one amplified control signal to the transformer element; and
an output buffer receiving the transformer element and changing the level of the at least one electric signal to generate the at least one switch signal.

9. A power supply device drving at feast one load, comprises:
a DC isolation power unit having a primary side and a secondary side, wherein the primary side is coupled to an AC voltage source, and the secondary side provides a DC voltage according to the AC voltage source; and
a DC/AC inverter inverting the DC voltage to an AC signal to drive the load;
wherein the primary side is coupled to a first ground, the secondary side and the DC/AC inverter are coupled to a second ground.

10. The power supply device as claimed in claim 9, wherein the DC/AC inverter comprises:
a switch unit receiving the DC voltage and at least one control signal and switching the DC voltage to an oscillation signal according to the at least one control signal;
a resonance network coupled to the switch unit, receiving the oscillation signal, and transforming the oscillation signal to a operating signal; and
a controller receiving a feedback signal indicating the electrical states of the load and generating the at least one control signal according to the feedback signal.

11. The power supply device as claimed in claim 10, wherein the controller comprises:
a load indicator receiving the feedback signal and generating an indication signal; and
a signal generator generating the at least one control signal according to the indication signal.

12. The power supply device as claimed in claim 11, wherein the controller further comprises:
a detector detecting that the lamp is at an open or short state;
wherein the detector outputs a stop signal to the signal generator when the lamp is at the open or short state, so that the signal generator stops outputting the at least one control signal.

13. The power supply device as claimed in claim 10, wherein the at least one control signal is a pulse width modulation (PWM) signal.

14. The power supply device as claimed in claim 9, wherein the DC isolation power unit comprises:
a transformer element coupled to the AC voltage source, transforming a signal from the AC voltage source to a non-electric signal and then transforming to an electric signal;
a converter coupled to the transformer element and converting the electric signal to the DC voltage.

15. The power supply device as claimed in claim 14, wherein the transformer element is a transformer.

16. The power supply device as claimed in claim 14, wherein the converter comprises a plurality of diodes and a capacitor.

17. The power supply device as claimed in claim 9, wherein the load is a fluorescent lamp.
